(19) United States
(12) Patent Application Publication
(10) Pub. No.: US 2018/0316002 A1
(43) Pub. Date: Nov. 1, 2018

(54) CARBON-SILICON COMPOSITE MATERIAL, NEGATIVE ELECTRODE, AND SECONDARY BATTERY

(71) Applicant: Tec One Co., Ltd., Nomi-shi (JP)

(72) Inventor: Takahiro KITANO, (US)

(73) Assignee: Tec One Co., Ltd., Nomi-shi (JP)

(21) Appl. No.: 15/574,703

(22) PCT Filed: Apr. 27, 2017
(86) PCT No.: PCT/JP2017/016802

§ 371 Date: Nov. 16, 2017

(51) Int. Cl. H01M 4/36; H01M 4/587; H01M 4/38

(52) U.S. Cl. CPC H01M 4/366; H01M 2004/027; H01M 4/386; H01M 4/587

(57) ABSTRACT

A carbon-silicon composite material is suitable to be used as a negative electrode material for battery. It is a carbon-silicon composite material having such a structure that a silicon particle exists in a resin thermolysis product, wherein, in a case where the carbon-silicon composite material is dipped into an electrolytic solution ((ethylene carbonate/diethyl carbonate (1/1 (volume ratio))) under the conditions of 760 mmHg, 30° C., and 60 min., liquid adsorption of the electrolytic solution per the carbon-silicon composite material of 1 g is 0.65-1.5 mL.

### TECHNICAL FIELD

The present invention relates to a carbon-silicon (C—Si) composite material.

### BACKGROUND ART

A carbon material (carbon material for the use of non-aqueous secondary battery negative electrode) is disclosed in the below mentioned Patent Literatures.

### CITATION LIST

### Patent Literature

[PATENT LITERATURE 1] JP 2008-186732 A
[PATENT LITERATURE 2] WO2013/130712
[PATENT LITERATURE 3] JP 2015-135811 A

### SUMMARY OF INVENTION

### Technical Problem

Even in a case where a negative electrode of a secondary battery was formed of a carbon material disclosed in the above listed Patent Literatures 1, 2, and 3, a satisfactory negative electrode could not be obtained.

To solve the above problem, the present invention provides a carbon-silicon composite material suitable to be used as a negative electrode material.

### Solution to Problem

The present invention proposes a carbon-silicon composite material having such a structure that a silicon particle exists in a resin thermolysis product:

wherein, in a case where the carbon-silicon composite material is dipped into an electrolytic solution ((ethylene carbonate/diethyl carbonate (1/1 (volume ratio))) under the conditions of 760 mmHg, 30° C., and 60 min., liquid adsorption of the electrolytic solution per the carbon-silicon composite material of 1 g is 0.65-1.5 mL.

The present invention proposes the carbon-silicon composite material:

wherein the resin thermolysis product comprises a concavity; and

wherein the carbon-silicon composite material has such a structure that the electrolytic solution enters into the concavity when the carbon-silicon composite material is dipped into the electrolytic solution.

The present invention proposes a carbon-silicon composite material having such a structure that a silicon particle exists in a resin thermolysis product:

wherein the resin thermolysis product comprises a concavity; and

wherein the concavity has a volume of ¼-½ of a virtual outside volume of the carbon-silicon composite material.

The present invention proposes a carbon-silicon composite material having such a structure that a silicon particle exists in a resin thermolysis product:

wherein the resin thermolysis product comprises a concavity; and

wherein the concavity

has a length in a depth direction of the carbon-silicon composite material of ⅕-1/1 of a diameter of the carbon-silicon composite material.

The present invention proposes the carbon-silicon composite material, wherein an opening area ratio of the concavity, i.e., {(area of an opening portion in a surface of the composite material obtained in SEM observation)/(area of a surface of the composite material obtained in SEM observation)}, is 25-55%.

The present invention proposes the carbon-silicon composite material, wherein an opening area of the concavity is 10-100000 nm².

The present invention proposes the carbon-silicon composite material, wherein the concavity is one or two or more selected from the group including groove, hole, and aperture.

The present invention proposes the carbon-silicon composite material, wherein the silicon particle comprises a Si particle simple substance.

The present invention proposes the carbon-silicon composite material, wherein the silicon particle comprises a plurality of silicon particles, and the plurality of silicon particles are bound via the resin thermolysis product.

The present invention proposes the carbon-silicon composite material, further comprising:

a carbon black;

wherein the silicon particle and the carbon black are bound via the resin thermolysis product.

In other words, the present invention proposes the carbon-silicon composite material, further comprising:

the silicon particle, the resin thermolysis product, and a carbon black;

wherein the silicon particle and the carbon black are bound via the resin thermolysis product.

The present invention proposes the carbon-silicon composite material, wherein the carbon black has a primary particle size of 21-69 nm.

The present invention proposes the carbon-silicon composite material, wherein the silicon particle has a grain size of 0.05-3 μm.

The present invention proposes the carbon-silicon composite material, wherein a silicon content is 20-96 mass %.

The present invention proposes the carbon-silicon composite material, wherein a carbon content is 4-80 mass %.

The present invention proposes the carbon-silicon composite material, wherein the carbon-silicon composite material is a particle having a diameter of 1-20 μm.

The present invention proposes the carbon-silicon composite material, wherein the carbon-silicon composite material is a fiber having a fiber diameter of 0.5-6.5 μm and a fiber length of 5-65 μm.

The present invention proposes the carbon-silicon composite material, wherein the resin is a thermoplastic resin.

The present invention proposes the carbon-silicon composite material, wherein the resin comprises (contains) polyvinyl alcohol as a main component.

The present invention proposes the carbon-silicon composite material, wherein the carbon-silicon composite material is used as a negative electrode material for battery.

The present invention proposes a negative electrode made of the carbon-silicon composite material.

The present invention proposes a secondary battery comprising the negative electrode.

### Advantageous Effect of Invention

The present invention provides a C—Si composite material suitable (long cycle life; high rate characteristic) to be used as a negative electrode material for battery.

### BRIEF DESCRIPTION OF DRAWINGS

FIG. 1 is a side view schematically illustrating a centrifugal spinning apparatus.

FIG. 2 is a top view schematically illustrating the centrifugal spinning apparatus.

FIG. 3 is a view schematically illustrating a yarn spinning and drawing apparatus.

FIG. 4 is a SEM picture.

FIG. 5 is a schematic diagram.

FIG. 6 is a SEM picture.

FIG. 7 is a SEM picture.

FIG. 8 is a SEM picture.

FIG. 9 is a SEM picture.

FIG. 10 is a SEM picture.

FIG. 11 is a SEM picture.

FIG. 12 is a SEM picture.

FIG. 13 is a SEM picture.

FIG. 14 is a SEM picture.

### DESCRIPTION OF EXAMPLES

A first invention is a carbon-silicon (C—Si) composite material. The carbon-silicon (C—Si) composite material comprises (contains, includes) a silicon particle and a resin thermolysis product. The silicon particle (Si particle) exists in the resin thermolysis product. The Si particle (metallic silicon particle) is a particle, preferably, containing an elemental silicon. The Si particle has a Si particle simple substance (an elemental silicon). The Si particle simple substance is a particle existing only with Si. The Si particle simple substance excludes a Si chemical compound. For example, in a case where the Si particle is composed only with a SixOy (x and y are arbitrary numbers, wherein y≠0) particle (in a case where no Si particle simple substance is contained), the characteristic of the present invention cannot be produced. The resin thermolysis product is basically composed of C (carbon element). For example, the resin thermolysis product exists on a surface of the Si particle. Preferably, the resin thermolysis product exists covering the entire surface of the Si particle. For example, the Si particle is coated (covered) with the resin thermolysis product. Preferably, the entire surface of the Si particle is coated (covered) with the resin thermolysis product. As a matter of course, such a structure that a portion of the Si particle is not covered by the resin thermolysis product (is exposed) is also acceptable. Preferably, the Si particle comprises (includes) a plurality of (two or more) Si particles. In a case where there is a plurality of (two or more) Si particles, the plurality of Si particles is bound via the resin thermolysis product. This is figuratively described that the plurality of particles (the plurality of Si particles) exists in the sea (the resin thermolysis product). Preferably, a Si content is 20-96 mass %. Preferably, a C content is 4-80 mass %. In a case where the carbon-silicon composite material is dipped into an electrolytic solution ((ethylene carbonate/diethyl carbonate) (1/1 (volume ratio))) under conditions of 760 mmHg, 30° C., and 60 min., a liquid adsorption of the electrolytic solution per the carbon-silicon composite material of 1 g is 0.65-1.5 mL. Preferably, the liquid adsorption was 0.7 mL or more. More preferably, the liquid adsorption was 0.8 mL or more. Preferably, the liquid adsorption was 1.2 mL or less. More preferably, the liquid adsorption was 1.1 mL or less.

The C—Si composite material comprises (includes) a Si particle and a resin thermolysis product. The Si particle exists in the resin thermolysis product. The resin thermolysis product has a concavity. In a case where the C—Si composite material is dipped into the electrolytic solution, preferably, the C—Si composite material has such a structure that the electrolytic solution enters into the concavity.

Preferably, a volume of the concavity (total volume of the concavity having a size into which the electrolytic solution can enter (all the concavities (but excluding small concavities into which the electrolytic solution cannot enter)) was ¼-½ of a virtual outside volume of the C—Si composite material. More preferably, the volume of the concavity was 6/20 or more. Further preferably, the volume of the concavity was 9/20 or less. The C—Si composite material comprises (has) the concavity. The concavity connects with the outside space. Therefore, when a volume of the C—Si composite material is referred to, the volume might be regarded as a volume after a volume of the concavities is excluded. The virtual outside volume is defined as a volume where no concavity exists (a volume when it is assumed that a concavity connected to the outside space is filled with a C—Si composite material; a volume when it is assumed that a surface of an adjacent area of an opening portion (a boundary between the outside space and an inside of the C—Si composite material) of the concavity is naturally expanded to close the opening portion). A volume of the concavity is calculated by an increase in weight when the C—Si composite material is dipped into the electrolytic solution and a density of the electrolytic solution.

The virtual outside volume can be obtained on the basis of a value measured from a shape obtained from an observation picture of a scanning electron microscope of a C—Si composite material.

As a method for calculating a ratio between the virtual outside volume and the volume of the concavity, there is a calculation method performed on the basis of a volume contraction rate, weight reduction percentage, and true density after heating in a heating process when producing a C—Si composite material. The value can be obtained from

[virtual volume]=[volume before heating]×[volume contraction rate],

([virtual volume]−[volume of concavity])=[weight before heating]×[weight reduction percentage after heating]/[true density after heating]

and

[volume of concavity]=1−(([virtual volume]−[volume of concavity])/[virtual volume])

Preferably, a length in a depth direction of the concavity in the C—Si composite material was ¼-1/1 of a diameter of the C—Si composite material. More preferably, the length was ⅖ or longer. Further preferably, the length was 19/20 or shorter. The length of ¼ means that the concavity is not a through hole. The length of 1/1 means that the concavity is a through hole. That is because a shallow depth of the concavity substantially means a state of absence of concavity. That is, when the concavity comes into the inside of the C—Si composite material, the state produces the characteristic of the present invention.

Preferably, an opening area ratio of the concavity, i.e., {(area of an opening portion in a surface of the composite material in SEM observation)/(area of a surface of the composite material in SEM observation)}, was 25-55%. More preferably, the ratio was 30% or higher. Further preferably, the ratio was 45% or lower. In the present invention, preferably, the electrolytic solution (e.g., ethylene carbonate (C₃H₄O₃) and/or diethyl carbonate (C₅H₁₀O₃), lithium ion) can enter into the inside of the C—Si composite material. In order for the electrolytic solution to come (enter) into the inside of the C—Si composite material, an area of the opening portion of the concavity needs to have a predetermined (larger than C₃H₄O₃, C₅H₁₀O₃, Li⁺, etc.) size. From this point of view, a preferable area of the opening portion was 10-100000 nm² (nm²=(nm)²). When a size of the area is about a size equal to a gas (e.g., N₂, Ar, and CO) used for measurement of a BET specific surface area, the electrolytic solution cannot enter. The area, however, is not necessarily large. A fact that the area is large means that a space within the concavity is large. This causes the composite material to have a small mechanical strength. As a result, a volume change of Si particle according to charge and discharge might damage the composite material. Therefore, the above described conditions were preferred.

The concavity has, for example, a groove shape. Alternatively, the concavity is, for example, a hole (not a through hole). Alternatively, the concavity is, for example, an aperture (a through hole). The concavity may have any one of the above shapes, or two or more of the above shapes. The C—Si composite material has a shape of, for example, a trunk of pine. A trunk of pine generally has a groove (concavity) on its surface.

The C—Si composite material comprises (includes) a space (a space (void) connecting to the outside) of the above described size. Therefore, a volume change of Si particle according to charge and discharge can be moderated. The electrolytic solution can come (enter) into the inside of the C—Si composite material. The concavity is of a size allowing the electrolytic solution to enter thereinto. The entrance of the electrolytic solution (lithium ion) makes a distance between the lithium ion and an active material shorter. This enables a prompt charge and discharge (high rate characteristic).

Therefore, even if there is a small space (space into which an electrolytic solution cannot come (enter)), such a small space is useless in the present invention. In a case where there exist a lot of such small spaces, a bulking value of the total volume of the spaces becomes larger. This, however, is useless in the present invention. For example, the BET Specific Surface Area method measures up to a small space. Therefore, the present invention cannot be regulated by a characteristic value of a BET specific surface area. More specifically, a space about a size in which the electrolytic solution can move is required. To the contrary, a too large space has a problem as described above.

Preferably, the present invention further comprises (includes) a carbon black (or a carbon nanotube (preferable fiber diameter is 1-100 nm (more preferable diameter is 10 nm or less))). Preferably, the Si particle and the carbon black powder (also referred to as “CB particle”) exist in the resin thermolysis product. For example, the resin thermolysis product exists on surfaces of the Si particle and the CB particle. In other words, the Si particle and the CB particle are bound via the resin thermolysis product. This is figuratively described that a plurality of particles (the Si particle and the CB particle) exists in the sea (the resin thermolysis product).

Preferably, the carbon black had a primary particle size (grain size of a CB particle in a dispersion state) of 21-69 nm. More preferably, the carbon black had a primary particle size less than 69 nm. Further preferably, the carbon black had a primary particle size of 60 nm or less. Still further preferably, the carbon black had a primary particle size of 55 nm or less. In a case where the primary particle size of the CB particle was too large, the cycle characteristic showed a degradation trend. In a case where the primary particle size of the CB particle was too small, the cycle characteristic showed a degradation trend. The primary particle size (average primary particle size) can be obtained by, for example, a transmission electron microscope (TEM). The primary particle size can be obtained also by a Specific Surface Area by Gas Adsorption (gas adsorption method). Alternatively, the primary particle size can be obtained also by an X-ray scattering technique. The values of the primary particle size (average primary particle size) were obtained by the TEM.

Preferably, the Si particle had a grain size of 0.05-3 μm. More preferably, the Si particle had a grain size of 0.1 μm or more. Further preferably, the Si particle had a grain size of 0.2 μm or more. Still further preferably, the Si particle had a grain size of 0.25 μm or more. Especially preferably, the Si particle had a grain size of 0.3 μm or more. More preferably, the Si particle had a grain size of 2.5 μm or less. In a case where the grain size was too large, the C—Si composite material expanded largely. The cycle characteristic showed a degradation trend. An initial coulombic efficiency showed a lowering trend. In a case where the grain size was too small, the cycle characteristic showed a degradation trend. The initial coulombic efficiency showed a lowering trend. The grain sizes were obtained by an Energy Dispersive X-ray Spectroscopy (EDS). An electron ray was operated focusing on a characteristic X-ray (1.739 eV) of Si. X-ray mapping of silicon was performed. A size of Si particle was obtained from the obtained image.

Preferably, in the C—Si composite material, a resin-decomposed product (thermolysis product) exists on a surface of the Si particle. More preferably, the Si particle is covered by the thermolysis product. The Si particle is preferably covered in its entire surface. Here, it is acceptable if the particle is covered substantially. In so far as the characteristic of the present invention is not deteriorated largely, the Si particle is not necessarily covered in its entire surface. If the Si particle is covered with the thermolysis product, the Si particle (surface) can avoid a contact with an electrolytic solution of a lithium ion secondary battery. Therefore, a side reaction hardly occurs between the Si particle (surface) and the electrolytic solution. As a result, an irreversible capacity decreases.

In the C—Si composite material, exemplified is such a case that a resin-decomposed product (thermolysis product) exists on a surface of the Si particle (grain size: 0.05-3 μm). Preferably, the Si particle is covered with the thermolysis product. Preferably, the Si particle is covered in its entire surface. Here, it is acceptable if the particle is covered substantially. In so far as the characteristic of the present invention is not deteriorated largely, the Si particle is not necessarily covered in its entire surface. The reason thereof has been described above.

Preferably, in the C—Si composite material, a Si content was 20-96 mass %. More preferably, the Si content was 40 mass % or more. Further preferably, the Si content was 95 mass % or less. In a case where the Si content was too small, a capacity as an active material decreased. In a case where the Si content was too large, the conductivity was degraded. The cycle characteristic was lowered.

Preferably, in the C—Si composite material, a carbon content was 4-80 mass %. More preferably, the carbon content was 5 mass % or more. Further preferably, the carbon content was 7 mass % or more. Still further preferably, the carbon content was 10 mass % or more. More preferably, the carbon content was 60 mass % or less. In a case where the carbon content was too small, the cycle characteristic was lowered.

The Si content was obtained by C—Si analysis. More specifically, the C—Si composite material of a known weight was burned by a C—Si analyzing device. A C content was quantitatively measured by infrared measurement. The C content was extracted. Accordingly, a Si content was obtained. As it is known from the above, “C content ratio=C content/(C content+Si content), Si content ratio=Si content/(C content+Si content)”.

The C—Si composite material may contain impurities. It is not necessary to eliminate components other than the C component and the Si component.

A preferable shape of the composite material is an approximate spherical shape if a filling density of an electrode is important. A preferable shape of the composite material is an approximate fiber shape if the cycle characteristic is important.

The granular shaped (approximate spherical shaped) composite material had a particle size of 1-20 μm (diameter). In a case where the particle size was 1 μm or less, a specific surface area became large and a side reaction with an electrolytic solution relatively increased. An irreversible capacity increased. In a case where the particle size was beyond 20 μm, i.e., was large, there was a difficulty in treating the composite material when producing an electrode. More preferably, the particle size was 2 μm or more. Further preferably, the particle size was 5 μm or more. Still further preferably, the particle size was 15 μm or less. Further preferably, the particle size was 10 μm or less. It is not necessary for the composite material to have a perfect spherical shape. For example, the composite material may have an amorphous shape as illustrated in FIG. 9. A diameter thereof can be obtained by using a scanning electron microscope (SEM). The diameter thereof can be obtained also by a laser scattering method. The above described particle sizes were obtained by the SEM.

Preferably, the fiber shaped (approximate fiber shaped) composite material had a fiber diameter of 0.5-6.5 μm and a fiber length of 5-65 μm. In a case where the diameter was too large, there was a difficulty in treating when producing an electrode. In a case where the diameter was too small, productivity was degraded. In a case where the length is too short, the characteristic produced by a fiber shape was lost. In a case where the length was too long, there was a difficulty in treating when producing an electrode. More preferably, the diameter was 0.8 μm or more. Further preferably, the diameter was 5 μm or less. Further preferable length was 10 μm or more. Still further preferable length was 40 μm or less. The diameter was obtained on the basis of a SEM picture of the composite material. 10 fiber shaped composite materials were randomly extracted from a SEM picture of the composite material and an average diameter was calculated. In a case where the number of the fiber shaped composite material was 10 or less (N number), an average diameter was obtained on the basis of the N number of composite materials. The length was obtained on the basis of a SEM picture of a fiber shaped composite material. 10 fiber shaped composite materials were randomly extracted from a SEM picture of the fiber shaped composite material, and an average length thereof was obtained. In a case where the number of the fiber shaped composite materials was 10 or less (N number), an average length was obtained on the basis of the N number of composite materials.

When the spherical shaped composite material and the fiber shaped composite material were mixed to be used, a satisfactory result could be obtained in both the electrode density and the cycle characteristic.

Preferably, the resin was a thermoplastic resin. Examples of the thermoplastic resin include polyvinyl alcohol (PVA), polyvinylbutyral (PVB), cellulose resin (carboxymethyl cellulose (CMC), etc.), polyolefin (polyethylene (PE), polypropylene (PP), etc.), ester resins (polyethylene terephthalate (PET), etc.), and acrylic (methacrylic) resins. As a matter of course, examples of the thermoplastic resin are not limited to the above listed examples. Because the resin is subjected to a pyrolytic decomposition process, preferable resin is of a type which does not generate a toxic gas during the pyrolytic decomposition process. Preferably, the resin was a water soluble-resin. The preferable resin in the above listed resins was polyvinyl alcohol resins. The most preferable resin was PVA. The use of PVA alone is preferred as a matter of course. In so far as the advantageous characteristic of the present invention is not deteriorated largely, the other resins also can be used. The resin also includes a resin containing PVA as a main component. “PVA as a main component” means “PVA content/whole resin content ≥% 50 wt %”. Preferably, the PVA content is 60 wt % or more, more preferably, 70 wt % or more, further preferably, 80 wt % or more, especially preferably, 90 wt % or more. The reason why the PVA was the most preferable resin follows: With a decomposed product (thermolysis product) of PVA, a side reaction with an electrolytic solution of a lithium ion secondary battery hardly occurred. This involves decrease of an irreversible capacity. Further, the PVA is easily decomposed into water and carbon dioxide in the course of thermal decomposition. The remaining carbide is little. As a result, the Si content in the C—Si composite material is not lowered. For example, in a case where polyethylene glycol (molar weight of 20,000, produced by Wako Pure Chemical Industries, Ltd.) was used, a large amount of carbide was left during the modification (when heating) in comparison with a case where the PVA was used. As a result, the Si content was lowered. Further, the irreversible capacity was large. For example, the initial coulombic efficiency was low (43%). The cycle characteristic was low (32%).

Preferably, the PVA had an average molar weight (polymerization degree) of 2200-4000. More preferably, the average molar weight was 3000 or less. The polymerization degree was obtained according to the JIS K 6726. For example, the PVA of 1 part was dissolved in water of 100 parts. A viscosity (30° C.) was obtained by using the Ostowald Viscometer (relative viscometer). A polymerization degree (P_{A}) was obtained by the following equations (1) to (3).

log(P_{A})=1.613×log {([η]×104)/8.29} Equation (1)

[η]={2.303×log [ηrel]}/C Equation (2)

[ηrel]=t₁/t₀ Equation (3)

where P_{A}: polymerization degree, [η]: intrinsic viscosity, ηrel: relative viscosity, C: concentration of test solution (g/L), t₀: falling speed of water (s), and t₁: falling speed of test solution (s)

Preferably, the PVA had a saponification degree of 75-90 mol %. More preferably, a saponification degree was 80 mol % or higher. The saponification degree was obtained according to JIS K 6726. For example, according to an estimated saponification degree, a sample of 1-3 parts, water of 100 parts, and 3 drops of phenolphthalein are added to be completely dissolved. A NaOH aqueous solution of 25 ml (0.5 mol/L) was added, stirred, and left for 2 hours. A HCl aqueous solution of 25 ml (0.5 mol/L) was added. Titration was performed with the NaOH aqueous solution (0.5 mol/L). The saponification degree (H) was obtained by the following equations (1) to (3).

X₁={(a−b)×f×D×0.06005}/{S×(P/100)}×100 Equation (1)

X₂=(44.05×X₁)/(60.05−0.42×X₁) Equation (2)

H=100−X₂ Equation (3)

where

X₁: acetic acid content corresponding to residual acetic group (%)

X₂: residual acetic group (mol %)

H: saponification degree (mol %)

a: amount of use of NaOH solution (0.5 mol/l) (ml)

b: amount of use of NaOH solution (0.5 mol/l) at blank test (ml)

f: factor of NaOH solution (0.5 mol/l)

D: concentration of normal solution (0.1 mol/1 or 0.5 mol/l)

S: sampling amount (g)

P: pure content of sample (%)

The composite material may contain a C—Si composite material which does not have the above described characteristic. For example, if (volume of C—Si composite material having the characteristic of the present invention)/(volume of C—Si composite material having the characteristic of the present invention+volume of C—Si composite material not having the characteristic of the present invention)≥0.5 is satisfied, the characteristic of the present invention was not deteriorated largely. Preferably, the ratio is 0.6 or higher. More preferably, the ratio is 0.7 or higher. Further preferably, the ratio is 0.8 or higher. Still further preferably, the ratio is 0.9 or higher. The volume ratio is obtained by an electron microscope observation method or the like. From this point of view, the diameter can be regarded as an “average diameter”. The length can be regarded as an “average length”. The grain size can be regarded as an “average grain size”.

The composite material is, for example, a negative electrode material for battery.

A second invention is directed to a negative electrode. The second invention is directed to, for example, a negative electrode for secondary battery. The negative electrode is made by using the above described composite material.

A third invention is directed to a secondary battery. The secondary battery includes the negative electrode.

The composite material can be obtained via, for example, “dispersing liquid preparation step (Step I)”, “solvent removal step (spinning step: Step II)”, and “modification step (Step III)”. Summary of the steps are described below.

[Dispersing Liquid Preparation Step (Step I)]

A dispersing liquid comprises (contains, includes), for example, a resin, silicon, and a solvent. Specially preferably, the dispersing liquid further comprises (contains, includes) a carbon black.

A description is made provided that the resin is PVA. Descriptions are made provided that the other resins are also PVA.

Preferably, the PVA had a polymerization degree of 2200-4000 from a spinning point of view. More preferably, the polymerization degree was 3000 or lower. Preferably, a saponification degree was 75-90 mol %. More preferably, the saponification degree was 80 mol % or higher. In a case where the polymerization degree was too small, a yarn was susceptible to cutting at spinning. In a case where the polymerization degree was too large, spinning was hardly performed. In a case where the saponification degree was too low, the PVA was hardly soluble in water and spinning was hardly performed. In a case where the saponification degree was too large, viscosity was high and spinning was hardly performed.

The dispersing liquid may contain, as required, one or two or more selected from the group including vinyl resin (e.g., polyvinyl alcohol-based copolymer, polyvinylbutyral (PVB), etc.), polyethylene oxide (PEO), acrylic resin (e.g., polyacrylic acid (PAA), polymethyl methacrylate (PMMA), polyacrylonitrile (PAN), etc.), fluororesin (e.g., polyvinylidene difluoride (PVDF), etc.), naturally-occurring polymers (e.g., cellulose resin, cellulose derivative resins (polylactic acid, chitosan, carboxymethyl cellulose (CMC), hydroxyethyl cellulose (HEC), etc.)), engineering plastic resin (polyether sulfone (PES), etc.), polyurethane resin (PU), polyamide resin (nylon), aromatic polyamide resin (aramid resin), polyester resin, polystyrene resin, and polycarbonate resin. Any amount thereof may be acceptable in so for as an advantageous effect of the present invention is not deteriorated.

Specially preferably, the dispersing liquid comprises (contains) a CB having a primary particle size (average primary particle size) of 21-69 nm. In a case where a CB having a primary particle size of less than 21 nm is used, a specific surface area of the obtained carbon fiber increases. A bulk density, however, was lowered. A solid component concentration of a dispersing liquid did not increase and thus there was a difficulty in treating the dispersing liquid. In a case where a CB having a primary particle size beyond 69 nm was used, a specific surface area of the obtained carbon fiber became smaller. There was large contact resistance. In a case where a primary particle size of the CB particle was too large, the cycle characteristic showed a lowering trend. In a case where a primary particle size of the CB particle was too small, the cycle characteristic showed a lowering trend.

The solvent is selected one or two or more from the group including water, alcohol (e.g., methanol, ethanol, propanol, butanol, isobutyl alcohol, amyl alcohol, isoamyl alcohol, cyclohexanol, etc.), ester (e.g., ethyl acetate, butyl acetate, etc.), ether (e.g., diethyl ether, dibutyl ether, tetrahydrofuran, etc.), ketone (acetone, methyl ethyl ketone, methyl isobutyl ketone, etc.), aprotic polar solvent (e.g., N,N-dimethylformamide, dimethylsulfoxide, acetonitrile, dimethylacetamide, etc.), halogenated hydrocarbon (e.g., chloroform, tetrachloromethane, hexafluoroisopropyl alcohol, etc.), and acid (acetic acid, formic acid, etc.). Preferably, from an environmental perspective, the solvent was water or alcohol. Specially preferably, the solvent was water.

The dispersing liquid comprises (contains) the Si particle. The Si particle (metal silicon particle) substantially is an elemental silicon (silicon simple substance). “Substantially” means that the following cases are also included: a case where impurities are contaminated during a process; and a case where impurities are contaminated when a particle surface is oxidized while being kept in a container. The particle of the present invention may be any particle that contains elemental silicon. For example, the particle surface may be covered with other component. Alternatively, the particle may have such a structure that an elemental silicon is dispersed in a particle made of another component. For example, there is a Si particle covered with a carbon. In a case of the composite particle, it is sufficient that a grain size of the composite particle falls within the above described range. Whether the Si component contained in the carbon fiber is a simple substance or a chemical compound can be determined by a publicly known measurement method such as X-ray diffraction measurement (XRD).

From an aspect of strength and conductivity, the dispersing liquid may comprise (contain) a carbon nanotube (e.g., single-wall carbon nanotube (SWNT), multi-wall carbon nanotube (MWNT), and mixture thereof), etc., as required.

The dispersing liquid comprises (contains) dispersant, as required. The dispersant is, for example, a surfactant. Both a low molecular weight surfactant and a high molecular weight surfactant may be employed.

Preferably, the PVA (resin) and the Si are mixed at the following ratio. If a PVA content is too large, a Si content decreases. Conversely, if a PVA content is too small, the solvent removal step such as spinning and coating becomes difficult to be performed. Therefore, a preferable ratio was the Si of 5-200 pts·mass (more preferably, 10-100 pts·mass) based on the PVA of 100 pts·mass.

In a case where the CB is contained, a preferable ratio was [mass of the Si particle]/[mass of the CB+mass of the Si particle]=20-94%. Alternatively, a preferable total mass of the particle and the CB was 5-200 pts·mass (more preferably, 10-100 pts·mass) based on the PVA of 100 pts·mass. In a case where the mass of the CB was too large, a capacity as a negative electrode active material was lowered. In a case where the mass of the CB was too small, the conductivity was lowered.

In a case where concentration of solid component (component other than solvent) in the dispersing liquid was too high, the solvent removal step such as spinning was difficult to be performed. Conversely, in a case where concentration was too low, the solvent removal step such as spinning was also difficult to be performed. Preferable concentration of the solid component was 0.1-50 mass % (more preferable concentration was 1-30 mass %, further preferable concentration was 5-20 mass %). In a case where viscosity of the dispersing liquid was too high, for example, if spinning was employed as the solvent removal step, the dispersing liquid was hardly discharged through a nozzle at spinning. Conversely, in a case where viscosity was too low, spinning was difficult to be performed. Therefore, a preferable viscosity (viscosity at spinning: measured by a coaxial double cylinder type viscometer) of the dispersing liquid was 10-10000 mPa·S (more preferable viscosity was 50-5000 mPa·S, further preferable viscosity was 500-5000 mPa·S).

The dispersing liquid preparation step comprises, for example, a mixing step and a fining step. The mixing step is a step in which the PVA and the Si (and the CB) are mixed. The fining step is a step in which the Si (and the CB) is micronized. The fining step is a step in which the Si (and the CB) is applied with a shear force. Accordingly, the CB is decomposed because a secondary flocculation is broken up. It is no matter which step is performed first, the mixing step or the fining step. Both may be performed concurrently.

In the mixing step, there are a case where both the PVA and the Si (and the CB) are fine particles (solid state), a case where one is a fine particle and the other is a solution (dispersing liquid), and a case where both are solutions (dispersing liquids). To enhance operability, preferable case is a case where both the PVA and the Si (and the CB) are solutions (dispersing liquids).

In the fining step, for example, a medialess bead mill is employed. Alternatively, a bead mill is employed. Further alternatively, an ultrasonic irradiation apparatus is employed. Preferably, in order to be free from contamination of foreign matter, a medialess bead mill is employed. Preferably, in order to control a grain size of Si (and CB), a bead mill is employed. Preferably, in order to perform the step with a simple operation, an ultrasonic irradiation apparatus is employed. In the present invention, because a control of a grain size of Si (and CB) was a material point, a bead mill was employed.

[Solvent Removal Step: Spinning Step (Producing Step of Fiber Material (Carbon-Silicon Composite Fiber Precursor): Step II)]

The solvent removal step is a step in which a solvent is removed from the dispersing liquid. Specially, a step of obtaining a fiber shaped composite material precursor (carbon-silicon composite fiber precursor) in solvent removal steps is referred to as a spinning step.

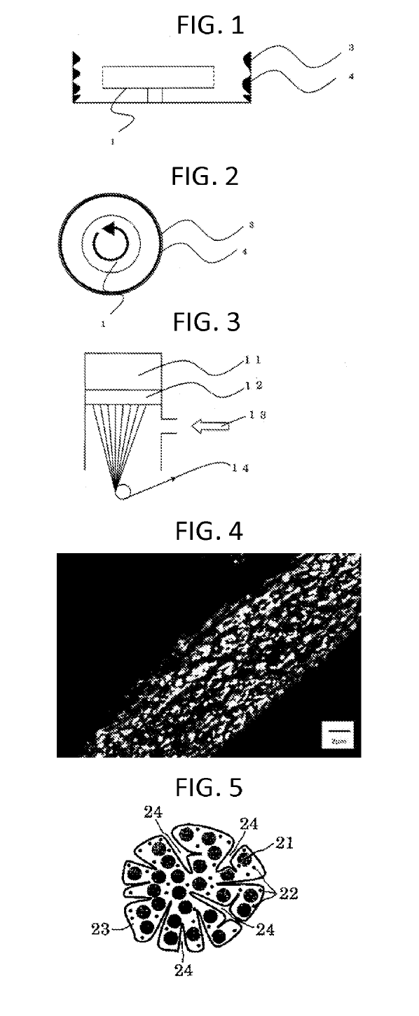

A centrifugal spinning apparatus of FIGS. 1 and 2 was employed for the spinning step. FIG. 1 is a schematic side view of a centrifugal spinning apparatus. FIG. 2 is a schematic top view of the centrifugal spinning apparatus. In the drawings, 1 denotes a spinning body (disk). The disk 1 is formed into a hollow body. A nozzle (or a hole) is provided on/in a wall of the disk 1. A spinning dope is charged into an inside (hollow portion) 2 (not shown) of the disk 1. The disk 1 is rotated at high speed. Accordingly, the spinning dope is drawn by a centrifugal force. Then, the spinning dope deposits on a collection plate 3 while the solvent is volatilized. A nonwoven fabric 4 is formed by the deposition.

A centrifugal spinning apparatus may have a heating device for heating the disk 1. A centrifugal spinning apparatus may have a spinning dope continuously supplying device. A centrifugal spinning apparatus is not limited to what are illustrated in FIGS. 1 and 2. For example, the disk 1 may be a vertical disk. Alternatively, the disk 1 may be fixed on a top of a centrifugal spinning apparatus. The disk 1 may be a bell type disk or a pin type disk which are used in a publicly known spray drying device. The collection plate 3 is not necessarily be a batch type collection plate but may be a continuous type collection plate. The collection plate 3 may be an inverse conical shaped cylinder that is used in a publicly known spray drying device. Heating of the entire solvent evaporating space is preferred because the solvent dries quickly. Preferably, a spinning rate (angle rate) of the disk 1 was 1,000-100,000 rpm. More preferably, the spinning rate was 5,000-50,000 rpm. This is because, in a case where the speed is too late, a stretching ratio becomes low. Higher speed is more preferred. However, the speed exceeding a certain upper limit value cannot achieve any greater improvement. Conversely, higher speed applied a larger load to the apparatus. Therefore, a preferable speed was set to 100,000 rpm or lower. In a case where a distance between the disk 1 and the collection plate 3 is too short, a solvent is hardly evaporated. Conversely, in a case where the distance is too long, the apparatus becomes larger more than required. A preferable distance differs according to a size of apparatus. In a case where a diameter of the disk was 10 cm, a distance between the disk 1 and the collection plate 3 was, for example, from 20 cm to 3 m.

Instead of the centrifugal spinning apparatus, a spinning and drawing apparatus may be employed. FIG. 3 is a schematic view illustrating a drying type spinning and drawing apparatus. Here, a drying type spinning and drawing apparatus is exemplified, but a wetting type spinning and drawing apparatus may be employed. A drying type spinning and drawing method is a method in which solidification is performed in the air. A wetting type spinning and drawing method is a method in which solidification is performed in a polyvinyl alcohol insoluble solvent. Both methods are employable. In FIG. 3, 11 denotes a tank (a tank of dispersing liquid (polyvinyl alcohol, a carbon black (a primary particle size of 21-69 nm), and a solvent are contained). 12 denotes a spinning nozzle. A dispersing liquid in the tank 11 is subjected to spinning via a spinning nozzle 12. At the time, a solvent is evaporated by heated air 13. The resulting dispersing liquid is wound as a yarn 14. In a wetting type spinning and drawing method, instead of the heated air, a polyvinyl alcohol insoluble solvent is employed. In a case where a stretching ratio is too large, a yarn is cut. In a case where a stretching ratio is too small, a fiber diameter does not become small. A preferable stretching ratio was 2-50 folds. More preferable stretching ratio is 3 folds or larger. Further preferable stretching ratio is 20 folds or smaller. In the present step, a carbon fiber precursor made-long fiber (yarn) can be obtained.

In the spinning and drawing method and the centrifugal spinning method, liquid having high viscosity (dispersing liquid having high solid component concentration) could be employed in comparison with a dispersing liquid employed in the electrostatic spinning method. The centrifugal spinning method is hardly affected by humidity (temperature) when compared with the electrostatic spinning method. Stable spinning could be performed for a long time. Productivity was high in the spinning and drawing method and the centrifugal spinning method. The centrifugal spinning method is a spinning method utilizing a centrifugal force. Therefore, a stretching ratio at spinning is high. Maybe, for this reason, an orientation of carbon particles in fiber was high. Conductivity was high. A diameter of thus obtained carbon fiber was small. Variation of fiber diameter was small. Contamination of metal powder was little. In a case of nonwoven fabric, a surface area was large.

The fiber material obtained in the present step (spinning step) is made of a composite material precursor. The precursor is a mixture of PVA and Si particle (preferably, CB is further contained). A plurality of nonwoven fabrics (made of the precursor) may be laminated. The laminated nonwoven fabric may be compressed by a roll, etc. A thickness and density are controlled, as required, by being compressed. A yarn (filament) may be wound around a bobbin.

A nonwoven fabric (made of a fiber precursor) is separated from a collector to be treated. Alternatively, the nonwoven fabric is treated while leaving it on a collector. Further alternatively, thus generated nonwoven fabric may be wound up around a stick in a manner similar to cooking of a cotton candy.

In a case of obtaining a fiber shaped composite material, a gel solidifying and spinning method can be employed in addition to the centrifugal spinning method, the spinning and drawing method, and the electrostatic spinning method.

In a case of obtaining a spherical shaped composite material, the following methods are also employable: a method for obtaining a film shaped C—Si composite material precursor by coating the dispersing liquid on a base material such as a polyester film or a release paper by means of a bar coater, a die coater, a kiss coater, a roll coater, etc., followed by drying thereof and a method for obtaining a spherical shaped C—Si composite material precursor by dropping the dispersing liquid into a PVA insoluble solvent that has a good compatibility with the solvent for coagulation thereof.

[Modification Step (Step III)]

A modification step is a step in which the composite material precursor is modified so as to be a C—Si composite material.

This step is basically a heating process. In the heating process, the composite material precursor is heated at, for example, 50-3000° C. Preferably, the composite material precursor was heated at 100° C. or higher. More preferably, the composite material precursor was heated at 500° C. or higher. Further preferably, the composite material precursor was heated at 1500° C. or lower. Still further preferably, the composite material precursor was heated at 1000° C. or lower.

A preferable heating time was 1 hour or longer.

Depending on the conditions in the present heating process, a C—Si composite material which does not satisfy the conditions of the present invention might be produced. Under the conditions as listed in the following examples, a C—Si composite material satisfying the conditions of the present invention could be obtained. Therefore, in a case where the heating process is performed under conditions different from conditions as listed in the following examples, the heating process should be performed with conditions by changing one of the conditions. When a characteristic (liquid adsorption of electrolytic solution) in a case where the heating process is performed by changing one of the conditions is measured, if the liquid adsorption of the electrolytic solution did not satisfy the requirements of the present invention, the conditions will be further changed a little. A similar process is performed. As a result, conditions different from the conditions listed in the below described examples can be found with ease.

Not only the conditions of the heating process but also selection of resin is a material factor. For example, polyacrylonitrile is hardly pyrolytically decomposed. Therefore, in a case where polyacrylonitrile is selected as a thermoplastic resin, it is highly probable that a C—Si composite material which does not satisfy the conditions of the present invention is produced. A thermal decomposition temperature of PVA is lower than a melting point thereof. Pyrolytic decomposition occurs easily. A shape of the precursor can be maintained even after heating process. When the PVA is used, a C—Si composite material satisfying the conditions of the present invention can be obtained with ease.

When a content of pitch or carbon fiber becomes larger, less amount is pyrolytically decomposed by heating process. Therefore, it is highly probable that a C—Si composite material which does not satisfy the conditions of the present invention is produced.

[Unraveling Step (Step IV)]

The present step is a step in which a size of the composite material obtained in the above step is reduced. The present step is a step in which the composite material precursor (composite material) obtained in, for example, the Step TI (or, the Step III) is unraveled. A pulverization (An unraveling) provides smaller composite material precursor (composite material). Striking of the fiber material also can decompose the fiber material. More specifically, striking also can provide a fiber.

A cutter mill, a hammermill, a pin mill, a ball mill, or a jet mill can be used for pulverization (unraveling). Both a wet type method and a dry type method can be employed. However, for the use in a nonaqueous electrolytic secondary battery, a dry type method is preferred.

A medialess mill will prevent a fiber from being collapsed. Therefore, a medialess mill is preferred to be employed here. For example, a cutter mill and an air jet mill are also preferred to be employed here.

Conditions of the present Step W affect a length and a grain size of a carbon fiber.

[Classification Step (Step V)]

The present step is a step in which a fiber of a desired size is selected from the fibers obtained in the Step IV. For example, a composite material which has passed through a sieve (mesh size of 20-300 μm) is used. In a case where a sieve having a small mesh size is used, a ratio of composite material which is not used becomes large. This involves increase of cost. In a case where a sieve having a large mesh size is used, a ratio of composite material which is used becomes large. In this case, however, quality of composite material varies. Other methods equivalent to using a sieve may also be used. For example, an airflow classifier (cyclone classifier) may also be used.

[Electrode]

The composite material is used as a material for electric element (including electron element). For example, the composite material is used as an active material of a negative electrode for lithium ion battery. The composite material is used as an active material of a negative electrode for lithium ion capacitor.

A lithium ion battery is made of various members (e.g., positive electrode, negative electrode, separator, and electrolytic solution). A positive electrode (or negative electrode) is formed in a manner as follows. A mixture including an active material (positive electrode active material or negative electrode active material), a conductive agent, a binder, etc. is laminated on a current collector (e.g., aluminum foil or copper foil). Accordingly, a positive electrode (or negative electrode) can be obtained.

The composite material of the present invention may be used alone as a negative electrode active material, or may be used with a publicly known negative electrode active material. In a case of a combined use, preferably, (content of the composite material)/(total content of the active material) is 3-50 mass %. More preferably, the ratio was 5 mass % or higher. Further preferably, the ratio was 10 mass % or higher. Further preferably, the ratio was 30 mass % or lower. Still further preferably, the ratio was 20 mass % or lower. Examples of the publicly known negative electrode active material include hardly graphitizable carbon, easily graphitizable carbon, graphite, pyrolytic carbons, cokes, glassy carbons, organic macromolecule chemical compound fired body, carbon fiber, or activated carbon. Examples of the publicly known negative electrode active material further include at least one selected from a group including a simple substance, alloy, and chemical compound of a metallic element capable of forming lithium alloy, a simple substance, alloy, and chemical compound of a semimetal element capable of forming lithium alloy (hereinafter referred to as “alloy system negative electrode active material”).

Examples of the metallic element (or semimetal element) include tin (Sn), lead (Pb), aluminum, Indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), or hafnium (Hf). Specific examples of chemical compound include LiAl, AlSb, CuMgSb, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), SnO_{w} (0<w≤2), SnSiO₃, LiSiO, and LiSnO. A lithium-titanium composite oxide (spinel type, ramsdellite type, etc.) is also preferred.

The positive electrode active material may be any substance that can occlude and emit lithium ion. Preferable examples thereof include a lithium-containing complex metal oxide and olivine type lithium phosphate.

The lithium-containing complex metal oxide is a metal oxide containing lithium and a transition metal. Alternatively, the lithium-containing complex metal oxide is a metal oxide in which a transitional metal is partially replaced with heteroelement. Preferably, the transition metal element comprises (contains, includes) at least one selected from the group including cobalt, nickel, manganese, and iron. Specific examples of the lithium-containing complex metal oxide include LiₖCoO₂, LiₖNiO₂, LiₖMnO₂, LiₖCoₘNi₁₋ₘO₂, LiₖCoₘM₁₋ₘOₙ, LiₖNi₁₋ₘMₘOₙ, LiₖMn₂O₄, LiₖMn₂₋ₘMnO₄, (M is at least one element selected from the group including Na, Mg, Sc, Y, Mn, Fe, Co, Ni, Cu, Zn, Al, Cr, Pb, Sb, and B. k=0-1.2, m=0-0.9, n=2.0-2.3).

The lithium-containing complex metal oxide has an olivine type crystal structure and can be a chemical compound (lithium iron phosphorus oxide) represented by a general formula of LiₓFe_{1-y}M_{y}PO₄ (M is at least one element selected from the group including Co, Ni, Cu, Zn, Al, Sn, B, Ga, Cr, V, Ti, Mg, Ca, and Sr. 0.9<x<1.2, 0≤y<0.3). For example, LiFePO₄ is suitable as such lithium iron phosphorus oxide.

As lithium thiolate, a chemical compound represented by a general formula of X—S—R—S—(S—R—S)n-S—R—S—X′ that is disclosed in EP Patent No. 415856 is employed.

In a case where a carbon fiber containing lithium thiolate and sulfur is used as a positive electrode active material, because the active material itself does not contain lithium ion, an electrode containing lithium such as a lithium foil is preferred as a counter electrode.

A separator is made of a porous film. A separator may be a laminated body made of two or more porous films. An example of the porous film includes a synthetic resin (e.g., polyurethane, polytetrafluoroethylene, polypropylene, and polyethylene) made-porous film. Also, a ceramic made-porous film may be employed.

An electrolytic solution contains a nonaqueous solvent and an electrolyte salt. Examples of the nonaqueous solvent include cyclic carbonic ester (propylene carbonate, ethylene carbonate, etc.), aliphatic ester (diethyl carbonate, dimethyl carbonate, ethyl methyl carbonate, etc.), and ethers (γ-butyrolactone, sulfolane, 2-methyltetrahydrofuran, dimethoxyethane, etc.). They can be used alone or in combination (two or more). From the perspective of oxidation stability, the carbonic acid ester is preferred.

Examples of the electrolyte salt include LiBF₄, LiClO₄, LiPF₆, LiSbF₆, LiAsF₆, LiAlCl₄, LiCF₃SO₃, LiCF₃CO₂, LiSCN, lower aliphatic carboxylic acid lithium, LiBCl, LiB₁₀Cl₁₀, halogenated lithium (LiCl, LiBr, LiI, etc.), borate salts (bis(1, 2-benzenediolate(2-)-O, O′) lithium borate, bis(2, 3-naphthalenediolate (2-)-O, O′) lithium borate, bis(2, 2′-biphenyldiolate(2-)-O, O′) lithium borate, bis(5-fluoro-2-oleate-1-benzenesulfonic acid-O, O′) lithium borate, etc.), and imide salts (LiN(CF₃SO₂)₂, LiN(CF₃SO₂)(C₄F₉SO₂), etc.). Lithium salt such as LiPF₆, LiBF₄ are preferred. LiPF₆ is specially preferred.

As an electrolytic solution, a gel electrolyte in which an electrolytic solution is held in a high-molecular compound may be employed. Examples of the high-molecular compound include polyacrylonitrile, polyvinylidene fluoride, copolymer of polyvinylidene fluoride and polyhexafluoropropylene, polytetrafluoroethylene, polyhexafluoropropylene, polyethylene oxide, polypropylene oxide, polyphosfazen, polysiloxane, polyvinyl acetate, polyvinyl alcohol, polymethyl methacrylate, polyacrylic acid, polymethacrylic acid, styrene-butadiene rubber, nitrile butadiene rubber, polystyrene, and polycarbonate. From the perspective of electrochemical stability, a high-molecular compound having a structure equivalent to polyacrylonitrile, polyvinylidene fluoride, polyhexafluoropropylene, or polyethylene oxide is preferred.

Examples of the conductive agent include graphite (natural graphite, artificial graphite, etc.), carbon black (acetylene black, ketjen black, channel black, furnace black, lampblack, thermal black, etc.), conductive fiber (carbon fiber, metallic fiber), metal (Al, etc.) powder, conductive whisker (zinc oxide, potassium titanate, etc.), electroconductive metallic oxide (titanium oxide, etc.), organic conductive material (phenylene derivative, etc.), and carbon fluoride.

Examples of the binder include polyvinylidene fluoride, polytetrafluoroethylene, polyethylene, polypropylene, aramid resin, polyamide, polyimide, polyamide imide, polyacrylonitrile, polyacrylic acid, poly(methyl acrylate), poly(ethyl acrylate), polyacrylic acid hexyl, polymethacrylic acid, polymethyl methacrylate, polyethyl methacrylate, poly(hexyl methacrylate), polyvinyl acetate, polyvinyl pyrrolidone, polyether, polyether sulphone, hexafluoro-polypropylene, styrene-butadiene rubber, modified acryl rubber, and carboxymethyl cellulose.

Hereinafter, substantial examples are listed. The present invention, however, will not be restricted to the following examples. In so far as the characteristic of the present invention would not be degraded largely, various deformation examples and application examples will also be included in the present invention.

### Example 1

PVA (product name: POVAL 217, saponification degree: 88 mol %, polymerization degree: 1700, produced by KURARAY CO., LTD.) of 58 pts·mass, metallic silicon (average grain size: 0.7 μm, produced by KINSEI MATEC CO., LTD.) of 37 pts·mss, carbon black (grain size: 30 nm) of 5 pts·mass, and water of 400 pts·mass were mixed by means of a bead mill. A metallic silicon dispersing liquid (PVA was dissolved) could be obtained.

The centrifugal spinning apparatus (see, FIGS. 1 and 2, distance between nozzle and collector: 20 cm, disk spinning number: 8,000 rpm) was used. The dispersing liquid was used to remove water via centrifugal spinning. A nonwoven fabric (made of a carbon-silicon composite material precursor) was produced on a collection plate. The obtained nonwoven fabric was heated (800° C., 3 hours, in a reducing atmosphere).

The obtained nonwoven fabric (made of a C—Si composite material) was treated by using a mixer. Accordingly, pulverization (unraveling) was performed. As a result, a fiber shaped C—Si composite material could be obtained.

The obtained fiber shaped C—Si composite material was classified. A sieve (mesh size: 50 μm) was used for the classification.

The obtained fiber shaped C—Si composite material was measured by means of a scanning electron microscope (VHX-D500, produced by KEYENCE CORPORATION). A result thereof is shown in FIG. 4. A fiber diameter was 5 μm and a fiber length was 24 μm. As a result of C—Si analysis by an infrared method, Si was 65 mass % and C was 35 mass %. FIG. 5 is a cross section view schematically illustrating a fiber shaped C—Si composite material of FIG. 4. In FIG. 5, 21 denotes a Si particle (Si metallic simple substance), 22 denotes a CB particle, 23 denotes a PVA thermolysis product, and 24 denotes a concavity. FIG. 5 (schematic view) illustrates the composite material by emphasizing the characteristic of the concavity thereof. It is apparent from FIG. 4 that the characteristic had not existed in the conventional C—Si composite material. It is found out that the C—Si composite material obtained in the present example comprises (contains, includes) a plurality of Si particles, a plurality of CB particles, and a resin thermolysis product. It is found out that the Si particles are bound via the resin thermolysis product. It was found out that the C—Si composite material (the resin thermolysis product) comprised (included, had) a space (void) of a predetermined size. A profile of the space (concavity) is shown in Table-1.

The composite material of 90 pts·mass, carbon black 7 pts·mass, carboxymethyl cellulose of 1 pts·mass, and styrene-butadiene copolymer particle of 2 pts·mass were dispersed in water of 400 pts·mass. The resulting dispersing liquid was coated on a copper foil. The copper foil was dried and pressed. A lithium ion battery negative electrode could be obtained. A lithium foil (counter electrode) was used. A mixture of ethylene carbonate (C₃H₄O₃) and diethyl carbonate (C₅H₁₀O₃) (1/1 (volume ratio):electrolytic solution)) was used. LiPF₆ (electrolyte) of 1 mol % was used. A coin cell for lithium ion battery was produced.

The coin cell was subjected to charge and discharge at a constant current (charge and discharge rate: 0.1 C, 1.0 C). A discharge capacity was measured. Subsequently, a cycle characteristic (a ratio based on an initial discharge capacity of a discharge capacity after 20 cycles) was measured after the charge and discharge at a constant current (charge and discharge rate: 0.1 C) was repeated for 20 times. A result thereof is shown in Table-2.

### Example 2

PVA (product name: POVAL 105, saponification degree: 99 mol %, polymerization degree: 1000, produced by KURARAY CO., LTD.) of 60 pts·mass, metallic silicon (average grain size: 0.7 μm, produced by KINSEI MATEC CO., LTD.) of 35 pts·mass, carbon black (grain size: 30 nm) of 5 pts·mass, and water of 400 pts·mass were mixed by means of a bead mill. A metallic silicon dispersing liquid (PVA was dissolved) could be obtained.

The dispersing liquid and a centrifugal spinning apparatus similar to that used in Example 1 were used to produce a nonwoven fabric (made of a carbon-silicon composite material precursor).

The obtained nonwoven fabric was heated (800° C., 3 hours, in a reducing atmosphere).

The obtained nonwoven fabric (made of a C—Si composite material) was processed by means of a mixer. Accordingly, pulverization (unraveling) was performed. A fiber shaped C—Si composite material could be obtained. The obtained fiber shaped C—Si composite material was pulverized (unraveled) by means of a jet mill.

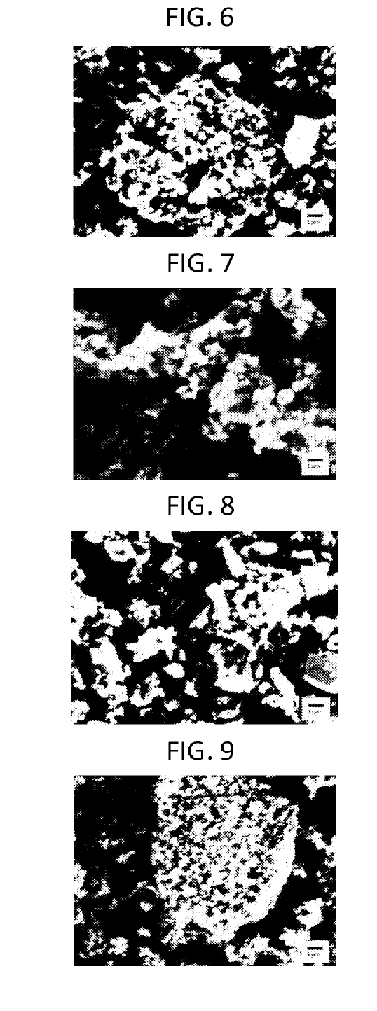

The obtained particle shaped C—Si composite material was measured by the VHX-D500. A result thereof is shown in FIG. 6. A grain size was 1-10 μm. As a result of C—Si analysis by an infrared method, Si was 55 mass % and C was 45 mass %. It was found out that the C—Si composite material (the resin thermolysis product) comprised (included, had) a space (void) of a predetermined size. A profile of the space (concavity) is shown in Table-1.

An electrochemical characteristic was measured in a manner similar to that performed in Example 1. A result thereof is shown in Table-2.

### Example 3

PVA (product name: POVAL 224, saponification degree: 88 mol %, polymerization degree: 2400, produced by KURARAY CO., LTD.) of 35 pts·mass, metallic silicon (average grain size: 0.7 μm, produced by KINSEI MATEC CO., LTD.) of 60 pts·mass, carbon black (grain size: 30 nm) of 5 pts·mass, and water of 400 pts·mass were mixed by means of a bead mill. A metallic silicon dispersing liquid (PVA was dissolved) could be obtained.

The dispersing liquid and a centrifugal spinning apparatus identical to that used in Example 1 were used to produce a nonwoven fabric (made of a carbon-silicon composite material precursor).

The obtained nonwoven fabric was heated (800° C., 2 hours, in a reducing atmosphere).

The obtained nonwoven fabric (made of a C—Si composite material) was processed by using a mixer. Accordingly, pulverization (unraveling) was performed. A fiber shaped C—Si composite material could be obtained. The obtained fiber shaped C—Si composite material was classified. A sieve (mesh size: 50 μm) was used for the classification.

The obtained fiber shaped C—Si composite material was measured by using the VHX-D500. A result thereof is shown in FIG. 7. A fiber diameter was 1-3 μm and a fiber length was 10-20 μm. As a result of C—Si analysis by an infrared method, Si was 89 mass % and C was 11 mass %. It was found out that the C—Si composite material (the resin thermolysis product) comprised (included, had) a space (void) of a predetermined size. A profile of the space (concavity) is shown in Table-1.

An electrochemical characteristic was measured in a manner similar to that performed in Example 1. A result thereof is shown in Table-2.

### Example 4

PVA (product name: POVAL 124, saponification degree: 99 mol %, polymerization degree: 2400, produced by KURARAY CO., LTD.) of 57 pts·mass, metallic silicon (average grain size: 0.7 μm, produced by KINSEI MATEC CO., LTD.) of 43 pts·mass, and water 400 pts·mass were mixed by means of a bead mill. A metallic silicon dispersing liquid (PVA was dissolved) could be obtained.

The dispersing liquid and a centrifugal spinning apparatus similar to that used in Example 1 were used to produce a nonwoven fabric (made of a carbon-silicon composite material precursor).

The obtained nonwoven fabric was heated (800° C., 5 hours, in a reducing atmosphere).

The obtained nonwoven fabric (made of a C—Si composite material) was processed by using a mixer. Accordingly, pulverization (unraveling) was performed. A fiber shaped C—Si composite material could be obtained. The obtained fiber shaped C—Si composite material was pulverized (unraveled) by means of a jet mill.

The obtained particle shaped C—Si composite material was measured by the VHX-D500. A result thereof is shown in FIG. 8. A grain size was 1-5 μm. As a result of C—Si analysis by an infrared method, Si was 72 mass % and C was 28 mass %. It was found out that the C—Si composite material (the resin thermolysis product) comprised (included, had) a space (void) of a predetermined size. A profile of the space (concavity) is shown in Table-1.

An electrochemical characteristic was measured in a manner similar to that performed in Example 1. A result thereof is shown in Table-2.

### Example 5

PVA (product name: POVAL 117, saponification degree: 99 mol %, polymerization degree: 1700, produced by KURARAY CO., LTD.) of 35 pts·mass, metallic silicon (average grain size: 0.2 μm, produced by KINSEI MATEC CO., LTD.) of 60 pts·mass, carbon black (grain size: 30 nm) of 5 pts·mass, and water 400 pts·mass were mixed by means of a bead mill. A metallic silicon dispersing liquid (PVA was dissolved) could be obtained.

The dispersing liquid and a centrifugal spinning apparatus identical to that used in Example 1 were used to produce a nonwoven fabric (made of a carbon-silicon composite material precursor).

The obtained nonwoven fabric was heated (800° C., 5 hours, in a reducing atmosphere).

The obtained nonwoven fabric (made of a C—Si composite material) was processed by using a mixer. Accordingly, pulverization (unraveling) was performed. A fiber shaped C—Si composite material could be obtained. The obtained fiber shaped C—Si composite material was pulverized (unraveled) by means of a jet mill.

The obtained particle shaped C—Si composite material was measured by the VHX-D500. A result thereof is shown in FIG. 9. A grain size was 1-10 μm. As a result of C—Si analysis by an infrared method, Si was 68 mass % and C was 32 mass %. It was found out that the C—Si composite material (the resin thermolysis product) comprised (included, had) a space (void) of a predetermined size. A profile of the space (concavity) is shown in Table-1.

An electrochemical characteristic was measured in a manner similar to that performed in Example 1. A result thereof is shown in Table-2.

### Example 6

PVA (the POVAL 217) of 60 pts·mass, metallic silicon (average grain size: 0.1 μm, produced by KINSEI MATEC CO., LTD.) of 37 pts·mass, carbon black (grain size: 30 nm) of 3 pts·mass, and water 400 pts·mass were mixed by means of a bead mill. A metallic silicon dispersing liquid (PVA was dissolved) could be obtained.

The dispersing liquid and a centrifugal spinning apparatus identical to that used in Example 1 was used to produce a nonwoven fabric (made of a carbon-silicon composite material precursor).

The obtained nonwoven fabric was heated (800° C., 5 hours, in a reducing atmosphere).

The obtained nonwoven fabric (made of a C—Si composite material) was processed by using a mixer. Accordingly, pulverization (unraveling) was performed. A fiber shaped C—Si composite material could be obtained. The obtained fiber shaped C—Si composite material was classified. A sieve (mesh size: 50 μm) was used for the classification.

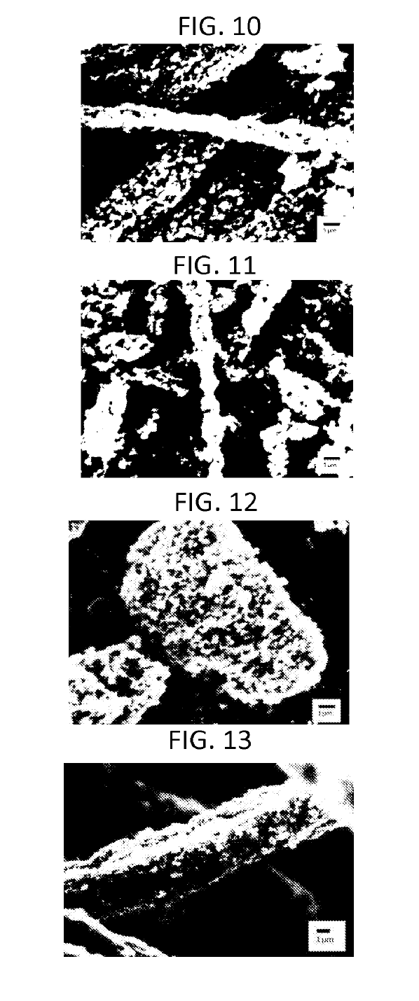

The obtained fiber shaped C—Si composite material was measured by the VHX-D500. A result thereof is shown in FIG. 10. A fiber diameter was 1-3 μm and a fiber length was 8-25 μm. As a result of C—Si analysis by an infrared method, Si was 67 mass % and C was 33 mass %. It was found out that the C—Si composite material (the resin thermolysis product) comprised (included, had) a space (void) of a predetermined size. A profile of the space (concavity) is shown in Table-1.

An electrochemical characteristic was measured in a manner similar to that performed in Example 1. A result thereof is shown in Table-2.

### Example 7

PVA (the POVAL 217) of 40 pts·mass, metallic silicon (average grain size: 0.08 μm, produced by KINSEI MATEC CO., LTD.) of 59.9 pts·mass, carbon nanotube (fiber diameter: 1 nm, fiber length: 10 μm) of 0.1 pts·mass, and water 400 pts·mass were mixed by means of a bead mill. A metallic silicon dispersing liquid (PVA was dissolved) could be obtained.

The dispersing liquid and a centrifugal spinning apparatus identical to that used in Example 1 were used to produce a nonwoven fabric (made of a carbon-silicon composite material precursor).

The obtained nonwoven fabric was heated (800° C., 4 hours, in a reducing atmosphere).

The obtained nonwoven fabric (made of a C—Si composite material) was processed by using a mixer. Accordingly, pulverization (unraveling) was performed. A fiber shaped C—Si composite material could be obtained. The obtained fiber shaped C—Si composite material was classified. A sieve (mesh size: 50 μm) was used for the classification.

The obtained fiber shaped C—Si composite material was measured by the VHX-D500. A result thereof is shown in FIG. 11. A fiber diameter was 0.5-3 μm and a fiber length was 5-35 μm. As a result of C—Si analysis by an infrared method, Si was 75 mass % and C was 25 mass %. It was found out that the C—Si composite material (the resin thermolysis product) comprised (included, had) a space (void) of a predetermined size. A profile of the space (concavity) is shown in Table-1.

An electrochemical characteristic was measured in a manner similar to that performed in Example 1. A result thereof is shown in Table-2.

### Example 8

PVA (the POVAL 217) of 63 pts·mass, metallic silicon (average grain size: 0.05 μm, produced by KINSEI MATEC CO., LTD.) of 35 pts·mass, carbon black (grain size: 30 nm) of 2 pts·mass, and water of 400 pts·mass were mixed by means of a bead mill. A metallic silicon dispersing liquid (PVA was dissolved) could be obtained.

The dispersing liquid and a centrifugal spinning apparatus identical to that used in Example 1 were used to produce a nonwoven fabric (made of a carbon-silicon composite material precursor).

The obtained nonwoven fabric was heated (800° C., 4 hours, in a reducing atmosphere).

The obtained nonwoven fabric (made of a C—Si composite material) was processed by using a mixer. Accordingly, pulverization (unraveling) was performed. A fiber shaped C—Si composite material could be obtained. The obtained fiber shaped C—Si composite material was pulverized (unraveled) by means of a jet mill.

The obtained particle shaped C—Si composite material was measured by the VHX-D500. A result thereof is shown in FIG. 12. A grain size was 6 μm. As a result of C—Si analysis by an infrared method, Si was 62 mass % and C was 38 mass %. It was found out that the C—Si composite material (the resin thermolysis product) comprised (included, had) a space (void) of a predetermined size. A profile of the space (concavity) is shown in Table-1.

An electrochemical characteristic was measured in a manner similar to that performed in Example 1. A result thereof is shown in Table-2.

### Comparison Example 1

PVA (the POVAL 124) of 60 pts·mass, metallic silicon (average grain size: 1 μm, produced by KINSEI MATEC CO., LTD.) of 20 pts·mass, carbon black (grain size: 30 nm) of 2 pts·mass, and water of 400 pts·mass were mixed by means of a bead mill. A metallic silicon dispersing liquid (PVA was dissolved) could be obtained.

The dispersing liquid and a centrifugal spinning apparatus identical to that used in Example 1 was used to produce a nonwoven fabric (made of a carbon-silicon composite material precursor).

The obtained nonwoven fabric was heated (300° C., 2 hours, in a reducing atmosphere).

The obtained nonwoven fabric (made of a C—Si composite material) was processed by using a mixer. Accordingly, pulverization (unraveling) was performed. A fiber shaped C—Si composite material could be obtained. The obtained fiber shaped C—Si composite material was classified. A sieve (mesh size: 50 μm) was used for the classification.

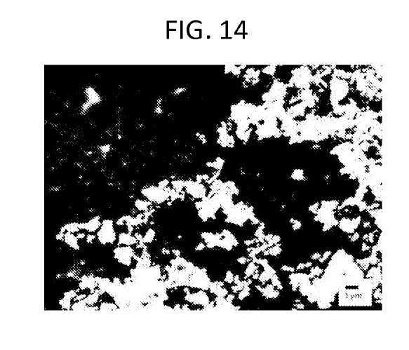

The obtained fiber shaped C—Si composite material was measured by the VHX-D500. A result thereof is shown in FIG. 13. A fiber diameter was 4 μm and a fiber length was 34 μm. As a result of C—Si analysis by an infrared method, Si was 38 mass % and C was 62 mass %. It was found out that the C—Si composite material (the resin thermolysis product) did not comprise (include) a space (void) of a predetermined size. A profile of the space (concavity) is shown in Table-1.

An electrochemical characteristic was measured in a manner similar to that performed in Example 1. A result thereof is shown in Table-2.

### Comparison Example 2

PVA (the POVAL 224) of 5 pts·mass, metallic silicon (average grain size: 1 μm, produced by KINSEI MATEC CO., LTD.) of 95 pts·mass, and water of 400 pts·mass were mixed by means of a bead mill. A metallic silicon dispersing liquid (PVA was dissolved) could be obtained.

The dispersing liquid and a centrifugal spinning apparatus identical to that used in Example 1 was used to produce a nonwoven fabric (made of a carbon-silicon composite material precursor).

The obtained nonwoven fabric was heated (800° C., 4 hours, in a reducing atmosphere).

The obtained nonwoven fabric (made of a C—Si composite material) was processed by using a mixer. Accordingly, pulverization (unraveling) was performed. A fiber shaped C—Si composite material could be obtained. The obtained fiber shaped C—Si composite material was pulverized (unraveled) by means of a jet mill.

The obtained particle shaped C—Si composite material was measured by the VHX-D500. A result thereof is shown in FIG. 14. As a result of C—Si analysis by an infrared method, Si was 98 mass % and C was 2 mass %. It was found out that the C—Si composite material (the resin thermolysis product) did not comprise (include) a space (void) of a predetermined size. A profile of the space (concavity) is shown in Table-1.

An electrochemical characteristic was measured in a manner similar to that performed in Example 1. A result thereof is shown in Table-2.

TABLE 1

| | electrolytic | | | |
|---|---|---|---|---|
| | solution liquid | concavity | | |
| | adsorption | | | opening area |
| | (mL/1 g) | depth (%) | volume (%) | ratio (%) |
| Example 1 | 0.95 | 32 | 27 | 40 |
| Example 2 | 0.87 | 72 | 31 | 41 |
| Example 3 | 1.12 | 91 | 32 | 52 |
| Example 4 | 0.71 | 97 | 30 | 45 |
| Example 5 | 1.02 | 23 | 42 | 48 |
| Example 6 | 1.22 | 56 | 48 | 32 |
| Example 7 | 1.46 | 83 | 37 | 30 |
| Example 8 | 1.05 | 44 | 38 | 27 |
| Comparison | 0.48 | 5 | 5 | 3 |
| Example 1 | | | | |
| Comparison | 0.55 | 1 | 1 | 1 |
| Example 2 | | | | |

electrolytic solution liquid adsorption: electrolytic solution (ethylene carbonate/diethyl carbonate (1/1 (volume ratio)) is used to perform measurement according to JIS-K 5101-13-1_2004 (Test methods for pigments - Part 13: Oil absorption - Section 1: Refined linseed oil method). A unit (mL/1 g) is electrolytic solution liquid adsorption per C - Si composite material of 1 g.
depth: (length in a depth direction of the concavity)/(diameter in a direction along the depth direction of the composite material) × 100 (%)
volume: (volume of space of the concavity)/(virtual outside volume of the composite material) × 100 (%)
opening area ratio: (area of opening portion in a surface of the composite material in SEM observation)/(area of a surface of the composite material in SEM observation) × 100 (%)

TABLE 2

| | | |
|---|---|---|
| discharge | | |
| capacity | rate | cycle |

| | 0.1 C | 1.0 C | characteristic | characteristic |
|---|---|---|---|---|
| Example 1 | 1364 | 1121 | 82.2% | 92.3% |
| Example 2 | 1354 | 1141 | 84.3% | 94.2% |
| Example 3 | 2391 | 2185 | 91.4% | 87.3% |
| Example 4 | 1742 | 1415 | 81.2% | 88.1% |
| Example 5 | 1650 | 1429 | 86.6% | 91.9% |
| Example 6 | 1649 | 1553 | 94.2% | 93.8% |
| Example 7 | 1987 | 1913 | 96.3% | 89.7% |
| Example 8 | 1563 | 1366 | 87.4% | 92.6% |
| Comparison | 785 | 272 | 34.7% | 84.5% |
| Example 1 | | | | |
| Comparison | 3265 | 699 | 21.4% | 16.8% |
| Example 2 | | | | |

A discharge capacity is a discharge capacity in a negative electrode. 0.1 C is a discharge capacity when a discharge rate is 0.1 C. 1.0 C is a discharge capacity when a discharge rate is 1.0 C. A unit of discharge capacity is mAh/g.
rate characteristic = (discharge capacity at 1.0 C)/(discharge capacity at 0.1 C)

It is found out that both the rate characteristic and the cycle characteristic of the C—Si composite materials of the Examples of the present invention improve in comparison with the C—Si composite materials of the Comparison Examples.

Further, a battery made of the C—Si composite material of the Examples had a high capacity and a small irreversible capacity.

### REFERENCE CHARACTER LIST

1 spinning body (disk)
3 collection plate
4 nonwoven fabric
11 tank
12 spinning nozzle
13 heated air
14 yarn

1: A carbon-silicon composite material having such a structure that a silicon particle exists in a resin thermolysis product:
wherein, in a case where the carbon-silicon composite material is dipped into an electrolytic solution comprising ethylene carbonate/diethyl carbonate at a 1:1 volume ratio under the conditions of 760 mmHg, 30° C., and 60 min., liquid adsorption of the electrolytic solution per the carbon-silicon composite material of 1 g is 0.65-1.5 mL.

2: The carbon-silicon composite material according to claim 1, wherein:
the resin thermolysis product comprises a concavity; and
the carbon-silicon composite material has such a structure that the electrolytic solution enters into the concavity when the carbon-silicon composite material is dipped into the electrolytic solution.

3: A carbon-silicon composite material having such a structure that a silicon particle exists in a resin thermolysis product, wherein:
the resin thermolysis product comprises a concavity; and
the concavity has a volume of ¼-½ of a virtual outside volume of the carbon-silicon composite material.

4: The carbon-silicon composite material according to claim 2,
wherein the concavity has a length in a depth direction of the carbon-silicon composite material of ⅕-1/1 of a diameter of the carbon-silicon composite material.

5: The carbon-silicon composite material according to claim 2, wherein an opening area ratio of the concavity, is 25-55%.

6: The carbon-silicon composite material according to claim 2, wherein an opening area of the concavity is 10-100000 nm².

7: The carbon-silicon composite material according to claim 2, wherein the concavity is at least one selected from the group consisting of groove, hole, and aperture.

8: The carbon-silicon composite material according to claim 1, wherein the silicon particle comprises a Si particle simple substance.

9: The carbon-silicon composite material according to claim 1,
wherein the silicon particle comprises a plurality of silicon particles; and
wherein the plurality of silicon particles is bound via the resin thermolysis product.

10: The carbon-silicon composite material according to claim 1, further comprising:
a silicon particle;
a resin thermolysis product; and
a carbon black;
wherein the silicon particle and the carbon black are bound via the resin thermolysis product.

11: The carbon-silicon composite material according to claim 10, wherein the carbon black has a primary particle size of 21-69 nm.

12: The carbon-silicon composite material according to claim 1, wherein the silicon particle has a grain size of 0.05-3 μm.

13: The carbon-silicon composite material according to claim 1, wherein a silicon content is 20-96 mass %.

14: The carbon-silicon composite material according to claim 1, wherein a carbon content is 4-80 mass %.

15: The carbon-silicon composite material according to claim 1, wherein the carbon-silicon composite material is a particle having a diameter of 1-20 μm.

16: The carbon-silicon composite material according to claim 1, wherein the carbon-silicon composite material is a fiber having a fiber diameter of 0.5-6.5 μm and a fiber length of 5-65 μm.

17: The carbon-silicon composite material according to claim 1, wherein the resin is a thermoplastic resin.

18: The carbon-silicon composite material according to claim 1, wherein the resin comprises polyvinyl alcohol as a main component.

19: The carbon-silicon composite material according to claim 1, wherein the carbon-silicon composite material is suitable as a negative electrode material for battery.

20: A negative electrode, wherein the negative electrode comprises the carbon-silicon composite material according to claim 1.

21: A secondary battery, wherein the secondary battery comprises the negative electrode according to claim 20.

22: The carbon-silicon composite material according to claim 3, wherein the concavity has a length in a depth direction of the carbon-silicon composite material of ⅕-1/1 of a diameter of the carbon-silicon composite material.

23: The carbon-silicon composite material according to claim 3, wherein an opening area ratio of the concavity is 25-55%.

24: The carbon-silicon composite material according to claim 3, wherein an opening area of the concavity is 10-100000 nm².

25: The carbon-silicon composite material according to claim 3, wherein the concavity is at least one selected from the group consisting of groove, hole, and aperture.

26: The carbon-silicon composite material according to claim 3, wherein the silicon particle comprises a Si particle simple substance.

27: The carbon-silicon composite material according to claim 3,
wherein the silicon particle comprises a plurality of silicon particles; and
wherein the plurality of silicon particles is bound via the resin thermolysis product.

28: The carbon-silicon composite material according to claim 3, further comprising:
a silicon particle;
a resin thermolysis product; and
a carbon black;
wherein the silicon particle and the carbon black are bound via the resin thermolysis product.

29: The carbon-silicon composite material according to claim 28, wherein the carbon black has a primary particle size of 21-69 nm.

30: The carbon-silicon composite material according to claim 3, wherein the silicon particle has a grain size of 0.05-3 μm.

31: The carbon-silicon composite material according to claim 3, wherein a silicon content is 20-96 mass %.

32: The carbon-silicon composite material according to claim 3, wherein a carbon content is 4-80 mass %.

33: The carbon-silicon composite material according to claim 3, wherein the carbon-silicon composite material is a particle having a diameter of 1-20 μm.

34: The carbon-silicon composite material according to claim 3, wherein the carbon-silicon composite material is a fiber having a fiber diameter of 0.5-6.5 μm and a fiber length of 5-65 μm.

35: The carbon-silicon composite material according to claim 3, wherein the resin is a thermoplastic resin.

36: The carbon-silicon composite material according to claim 3, wherein the resin comprises polyvinyl alcohol as a main component.

37: The carbon-silicon composite material according to claim 3, wherein the carbon-silicon composite material is suitable as a negative electrode material for battery.

38: A negative electrode, wherein the negative electrode comprises the carbon-silicon composite material according to claim 3.

39: A secondary battery, wherein the secondary battery comprises the negative electrode according to claim 38.
